(19) United States
(12) Patent Application Publication
(10) Pub. No.: US 2025/0083789 A1
(43) Pub. Date: Mar. 13, 2025

(54) HYBRID COMBINED CYCLE POWER SYSTEM

(71) Applicant: Siemens Energy AS, Oslo (NO)

(72) Inventor: Rune B Andersen, Oslo (NO)

(21) Appl. No.: 18/580,644

(22) PCT Filed: Sep. 12, 2022
(86) PCT No.: PCT/EP2022/075310

§ 371 Date: Jan. 19, 2024

(30) Foreign Application Priority Data
Sep. 14, 2021 (GB) 2113071.1

(51) Int. Cl. B63H 21/20; B63H 21/06; B63J 3/00; B63J 3/02; B63J 3/04; B63J 99/00

(52) U.S. Cl. CPC B63H 21/20; B63H 21/06; B63J 3/02; B63H 2021/207; B63J 2003/002; B63J 2003/043; B63J 2099/003

(57) ABSTRACT

A vessel hybrid combined cycle power and propulsion system includes a steam turbine, a gas turbine, an auxiliary generator, an electric propulsion drive system, and an energy storage system, each connected to an AC bus. The system further includes a source of steam for the steam turbine, a control system for controlling operation of the steam turbine, gas turbine, auxiliary generators, electric drive propulsion system and energy storage system. The primary source of steam for the steam turbine is exhaust gas from the gas turbine. The primary source of gas for the gas turbine is boil off gas from the cargo hold. The AC bus includes a plurality of sections of AC bus coupled together by bus ties closed in normal operation forming a closed ring AC bus. The electric propulsion drive system includes a variable speed drive, driving an electric motor coupled through a drive shaft to a propeller.

### BACKGROUND

This invention relates to a hybrid combined cycle power and propulsion system for a vessel, in particular for liquified natural gas (LNG) and hydrogen carriers.

Vessel operators require reductions operational costs, whilst conventional vessels are subject to increased restrictions on operations which may be harmful to the environment. Improved performance to address these is issues is desirable.

### SUMMARY

In accordance with the present invention a hybrid combined cycle power and propulsion system, the system includes a steam turbine, at least one gas turbine, at least one auxiliary generator; an electric propulsion drive system and an energy storage system, each connected to a section of an AC bus; the system further including a source of steam for the steam turbine, and a control system for controlling operation of the steam turbine, gas turbine, auxiliary generators, electric drive propulsion system and energy storage system; wherein the primary source of steam for the steam turbine is exhaust gas from the gas turbine; the primary source of gas for the gas turbine is boil off gas from the cargo hold; wherein the AC bus includes a plurality of sections of AC bus coupled together by bus ties closed in normal operation forming a closed ring AC bus; and the electric propulsion drive system includes a variable speed drive, driving an electric motor coupled through a drive shaft to a propeller.

The use of a closed ring system is made possible by having fast acting switches, e.g. semiconductor switches. Without these, conventionally, bus ties have been left open in normal operation because they cannot be opened sufficiently quickly in the event of a fault, to prevent the fault propagating into other parts of the system. In the event of a failure of supply in a conventional system, a bus tie can be closed to allow energy from a different bus to be supplied to consumers, but the sharing of supplies is not a standard feature of operation, so all buses need to have their open generators operating in normal use, which reduces efficiency.

The electric propulsion drive system may include a permanent magnet motor.

The use of a permanent magnet motor allows the system to run without a gear box because the permanent magnet motor can run sufficiently slowly to match the propeller speed, so there is no need for a gear box to bring the speed of the motor down to that of the propeller. Conventionally motors run at around 720 rpm and the propeller runs much more slowly, perhaps at closer to 1/10th of the motor speed.

The primary source of energy for the energy storage system may be electricity generated by one of the steam turbine, gas turbine, or auxiliary generators.

The system may further include a shore connection to enable the vessel consumers to be powered from the shore supply.

The system may include a single fuel gas turbine and one or more spark ignited auxiliary generators.

This helps to minimize emissions.

The propulsion system electric motor may include a low speed bi-directional motor coupled to each drive shaft and propeller of the vessel.

The propulsion system may further include bow thrusters electrically coupled to the AC bus. These are optional.

The vessel may include a liquified natural gas carrier, LPG carrier, hydrogen carrier and other large ships

The electric motor may include a bi-directional motor.

This avoids the need for a gearbox to move between forward and reverse. The variable frequency/variable speed drive is used to adjust the speed of forward or reverse propulsion.

The system may further include an onboard gas supply for the gas turbine.

### BRIEF DESCRIPTION OF THE DRAWINGS

An example of a vessel hybrid combined cycle power and propulsion system in accordance with the present invention will now be described with reference to the accompanying drawings in which:

FIG. 1 is a block diagram of an example of a hybrid combined cycle power and propulsion system according to the invention;

FIG. 2 illustrates part of the system of FIG. 1 in more detail;

FIG. 3 is a circuit diagram illustrating more detail of the example of FIG. 1 according to the invention;

FIG. 4 is a circuit diagram illustrating an alternative arrangement of the example of FIG. 1, with more detail;

FIG. 5 illustrates an example of power system operation for idling and waiting using a system according to the invention;

FIG. 6 illustrates an example of power system operation for maneuvering and low speed operation using a system according to the invention;

FIG. 7 illustrates an example of power system operation for cargo unloading using a system according to the invention;

FIG. 8 illustrates an example of power system operation for cargo loading using a system according to the invention;

FIG. 9 illustrates an example of power system operation for a sea going voyage using a system according to the invention;

FIG. 10 illustrates more detail of the propulsion part of the system for use with any of the examples of FIGS. 5 to 9.

### DETAILED DESCRIPTION

The present invention addresses the need to reduce operational expenditure on vessels, as well as enabling vessels to operate in a more environmentally friendly manner. Typically ships have three or four, four stroke engines installed for electrical power generation during maneuvering and terminal activity and slow speed two stroke engines for propulsion. LNG carriers have to deal with gas boil off from the cargo tanks during a voyage and traditionally, this gas has been used as fuel for engines and auxiliary steam boilers.

The present invention proposes a combination of energy sources in a hybrid combined cycle power plant with high efficiency permanent magnet propulsion motors.

An energy storage system (ESS) is included to ensure the most efficient operation of the power plant, allowing safe and reliable operation with only one combustion engine running in a closed ring distribution system.

Electrical power distribution is included in the hybrid system and the number of generators needed can be reduced by using energy storage. The total fuel spend on board the vessel includes fuel used for both steam and electricity. Conventionally, a fault in the gas turbine would trip the steam turbine and leave the vessel with no power for a period of time. Thus, vessels operating in this way had to have redundancy in running generators. The use of energy storage in combination with the steam and gas turbines avoids blackouts occurring and the energy storage also contributes to absorbing variable peak loads, enabling the gas turbine and steam turbine to operate with a stable load and at maximum operating efficiency. Thus, a vessel may be operated with only one gas turbine and one steam turbine installed together with other types of auxiliary generator, as the main propulsion generators are fed from the AC bus which has access to the energy storage system, in case of need, in the event of a fault in the main electrical energy supply. The high power required during sea going in heavy weather (the sea-margin) is covered by the auxiliary generators being operational, in addition to the gas turbine and the steam turbine. This means that a relatively small gas turbine and steam turbine with support from the energy storage, both normally operating at 90-100% load, i.e. at optimal efficiency produces a significant reduction in emissions and fuel consumption.

The steam turbine is driven by the gas turbine exhaust, which reduces the total emissions from the vessel and there are also capital cost reductions in only needing to have one gas turbine. The auxiliary generators are used as redundancy generators, as well as being operated during high load demand, maneuvering, waiting, and terminal operations. The energy storage acts as a short term back up to transfer from the steam turbine or gas turbine to one or more auxiliary spark-ignited four stroke gas engines. In normal operation, the main propulsion comes from the electricity generated by the gas turbine, once the vessel has reached a certain minimum cruising speed. The four stoke gas engines are sufficient to act as “get me home” engines. Further reductions in operating cost can be achieved with this hybrid combined cycle arrangement, as only one of the auxiliary engines is generally needed for loading and unloading of cargo, particularly with the assistance provided by the energy storage. As more power is needed to unload a vessel, typically both four stroke engines are in use for that, with the gas turbine on standby. As it takes about 6 to 10 minutes for the gas turbine to start up, then if a fault occurs with one of the four stroke engines, the other gas four stroke and the energy storage cover for this and there should be little effect on the loading or unloading operations. The gas turbine and the four stroke gas engines can both be fueled by the boil off gas from the cargo holds, which would otherwise be liquified and returned to the cargo tanks, or burnt off and wasted. In addition, provision of separate tanks for bunkering, for example zero carbon fuels, such as bioLNG and eLNG, allows the ship to still operate, even with empty cargo tanks.

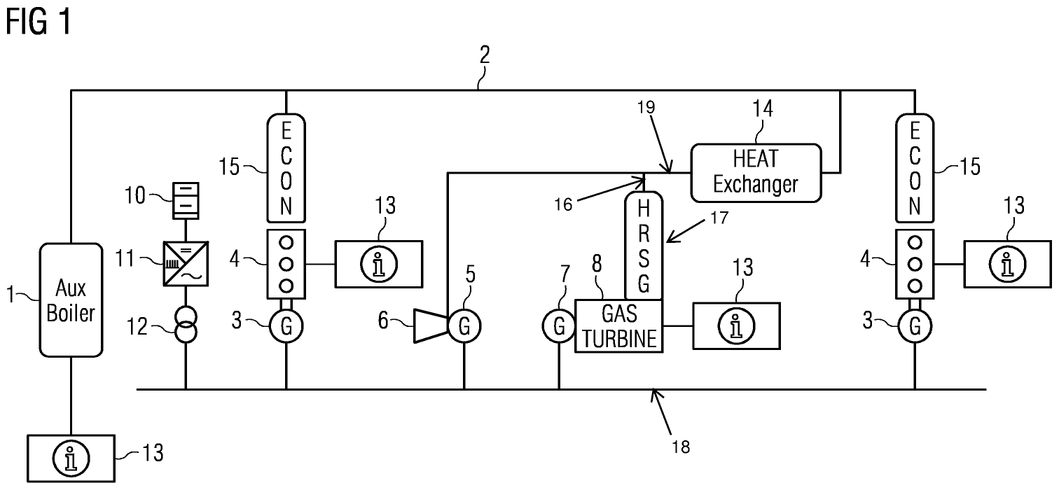

FIG. 1 is a block diagram illustrating an example of a hybrid combined cycle power and propulsion system according to the invention. The engine room can be made more compact than in conventional hybrid combined cycle systems with the combination of equipment chosen. The system include at least one auxiliary boiler 1 for generating steam, the boiler being coupled to a low pressure (LP) steam heating distribution network 2. Two auxiliary generators 3, typically receive power from four stroke gas engines 4 and feed this onto an AC bus 18. Each gas engine also feeds exhaust gas into an economiser 15 to generate steam to add to the steam heating distribution network 2. An energy storage system 10 is also connected to the electrical power distribution network 18, through a DC to AC converter 11 (CGC) and a transformer 12. Steam from the various sources in the distribution network 2 passes through a heat exchanger 14 and that output 19 is combined with an output 16 of a heat recovery steam generator 17 which takes exhaust from a gas turbine 8 and converts the exhaust to steam. The combination of steam outputs 16, 19 is fed into a steam turbine 6 to power a generator 5. Energy generated in the gas turbine 8 is converted to AC power in a generator 7 and input to the AC bus 18. The primary fuel source for the gas turbine 8 is boil off gas from the ship's liquified natural gas cargo.

The energy storage system 10 include a suitable store of energy, such as chemical or electrical energy storage, for example batteries, kinetic energy storage, such as flywheels, or other types of energy storage, such as capacitors, or super capacitors. The low pressure steam heating distribution 2 is coupled through the low pressure to high pressure steam heat exchanger 14 to the high pressure steam line and connected to the steam turbine and to an economiser 15 of the auxiliary engine exhaust waste heat recovery. Each of the auxiliary boiler 1, auxiliary generators 3 and gas turbine 8 are coupled to fuel metering devices 13, which provide data to control systems (not shown), so that the combination of operational energy sources may be optimised. The steam turbine 6 typically produces a half to a third of the power output of the gas turbine 8. An example of a gas turbine 7 that is suitable for this application is an SGT400 gas turbine, producing 12.9 MW of power, whereas the power output of the steam turbine 6 is typically lower, of the order of 5.6 MW. The new power system integrates the combined cycle power plant with the steam heating system. The heat recovery steam generator economizer may supply hot water to two steam flash vessels that provide more steam to the steam turbine, as well as hot water to a heat exchanger that pre-heats feedwater to the auxiliary boiler, reducing fuel consumption of the auxiliary boiler. In addition, pre-heating may be applied to the fuel gas using heat exchange to cool combustion air, so reducing the energy needed. This enables a significant improvement in the total fuel consumption to be achieved. For all of the examples given herein, the specific power outputs, operating voltages and gas turbine type and energy storage type used will depend on the customer requirement and the examples should not be treated as limiting.

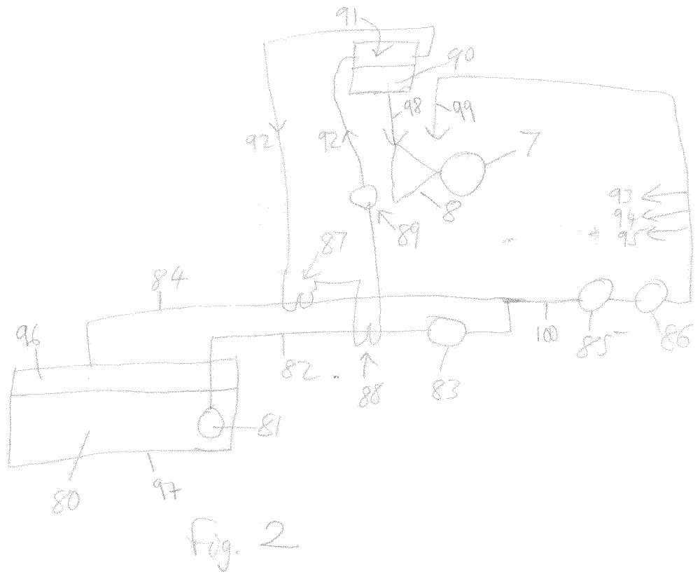

FIG. 2 shows an alternative view of elements of FIG. 1 to illustrate how the efficiency improvements are achieved in an liquified natural gas (LNG) carrier. LNG fuel 80 in one or more fuel tanks, or cargo tanks 97, naturally produces boil off gas 96 which is fed along pipelines 84 towards a fuel gas steam heater 85 and pump 86, which pumps the fuel gas towards fuel lines to generators 93, 94, the auxiliary boiler 95 and the gas turbine 8 and associated generator 7. Additional fuel 80 may be pumped by pump 81, directly from the one or more of the cargo tanks or fuel tanks along another pipeline 82 through forcing vaporiser steam heater 83 to the input 100 of the fuel gas steam heater 85. The pumped fuel is typically required during ballast operation, when there is high load, but low natural boil off gas production. As the boil off gas 96, or pumped fuel 80 are relatively cold, typically between −80° C. and −160° C. and must be heated up to a temperature above 2.5° C. (and for the gas turbine 8, supplied at a gauge pressure between 19.6 to 28 Bar (g)), before being presented to the various generators, boilers or turbines, then that property can be used to cool the combustion air 98 for the turbine 8.

Combustion air cooling is achieved by circulating the combustion air from combustion air source 91 through pipes 92 using a combustion air cooling pump 89. The combustion air flows through heat exchangers 87, 88 in contact with the boil off gas pipeline 84, or pumped fuel pipeline 82, respectively and is cooled down, then pumped back to supply cooled air 98 to the turbine. The effect of this combination of elements in the system is to reduce the amount of energy needed to heat up the fuel gas 99 for the turbine 8, as well as reducing the energy needed to cool down the combustion air 98 for the turbine. For example, typical steam consumption during ballast at 6 to 7 Bar (g), 170° C., the fuel gas heater 85 has steam capacity of 100 to 400 kg/h, requiring 80 to 300 kW at a typical rating of 650 kW and the forcing vaporiser has a steam capacity of 300 to 1400 kg/h, requiring 220 to 1050 kW at a typical rating of 1650 kW. To provide redundancy on the vessel, the example of FIG. 2 is actually duplicated, so that the vessel is still able to manoeuvre, even if a fault occurs in one part.

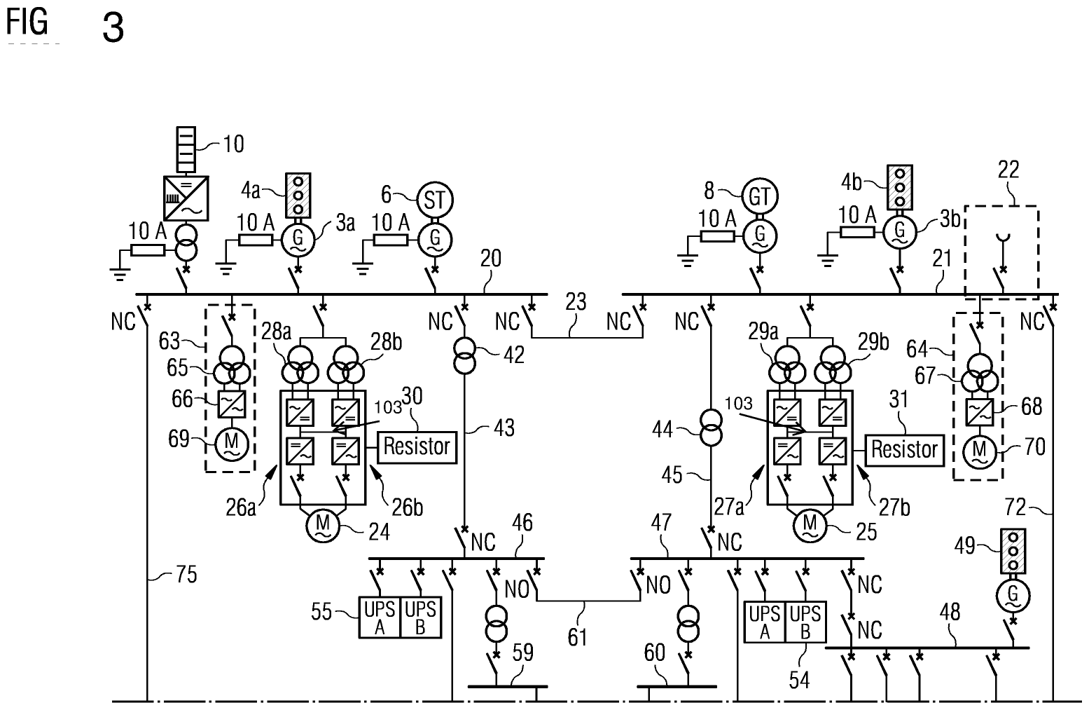

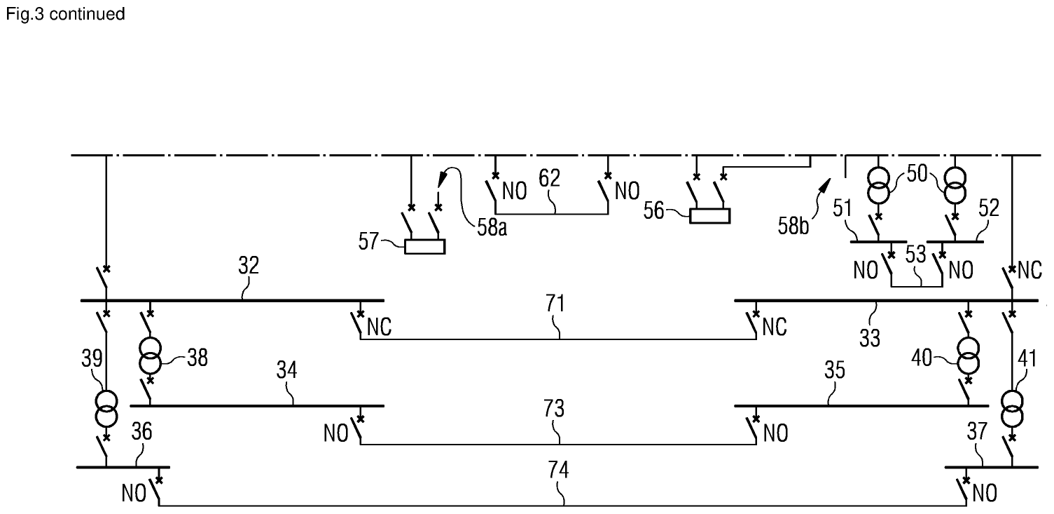

FIG. 3 is a single line diagram giving more detail of an example of the arrangement with the power generation split between two AC buses, rather than the single AC bus of FIG. 1 and with the AC buses connected in a closed ring arrangement to improve overall efficiency. A closed ring electrical distribution plant with energy storage enables minimal use of fuel by minimising the number of operational generators. The energy storage 10, in this example, battery packs producing 4.5MW of power; one of the auxiliary generators 3a, 4a, for example a spark ignited gas engine which may produce about 5.3MW of power; and a steam turbine 6, which may produce 5.6MW of power, may all be connected to one AC bus, or switchboard 20. These sources of power may produce fairly similar amounts of power. The gas turbine 8, the other auxiliary generator 3b, 4b and an optional shore supply connection 22 may be provided on a second AC bus 21. The two AC buses 20, 21, typically port and starboard on a twin engine vessel, may be coupled together via a coupling 23, with switches normally closed. These switchboards are typically operated at 6.6 kV AC. Main propulsion is provided by electrical variable speed motors 24, 25, each producing about 10.2 MW of power, one coupled to each switchboard 20, 21. The generated power from the AC bus is fed through AC to AC converter circuits 26a, 26b, 27a, 27b and transformers to the motor. The AC/AC conversion stages are connected together via a DC connection 103 and the AC/AC converter may include a breaking resistor 30, 31, as when reducing the speed of the ship, the propeller is rotated by the water and generates electrical energy which needs to be dissipated. In this example, the energy is used up in the breaking resistor. Alternatively, the energy could be stored in the energy storage system 10.

Electrical power is also supplied from the main switchboard 20, 21 to subsidiary switchboards, such as a directly connected cargo switchboard 32, 33 also operating at 6.6 kV AC, through connection 75, 72 with switches normally closed. The cargo switchboards 32, 33 are coupled together by a connection 71 with switches normally closed. The cargo switchboard 32, 33 connects to lower voltage consumer switchboards 34, 35 via a transformer 38, 40, operating in this example at 440V AC, or connects via other transformers 39, 41 to other consumer switchboards 36, 37 operating in this example at 220V AC. A connection 73 between lower voltage switchboards 34, 35 has switches normally open. Similarly, a connection 74 between the other consumer switchboards 34, 35 has switches normally open. The main switchboards also have connections 43, 45 via transformers 42, 44 to utility switchboards 46, 47 operating at 440V AC, with switches normally closed. In this example, the port utility switchboard 47 is shown connected, with switches normally closed, to an emergency switchboard 48, also at 440V AC, supplied by an emergency generator 49 and from this, via transformers to first and second emergency switchboards 51, 52 in this example at 220 VAC, may be coupled together through a coupling 53, set with switches normally open. The emergency switchboard supplies in this example a 220V AC general service UPS 56, 57 on both the port and starboard sides. (Although not shown, input 58a is also connected to emergency switchboard 48 through a connection from output 58b). The utility switchboards may also be connected to uninterruptable power supplies (UPS) at 110V DC, through an AC/DC rectifier (not shown), as well as being connected through transformers to 220V AC switchboards 59, 60. As with the main switchboard, the port and starboard sides of utility switchboards 46, 47 and 220V switchboards 59, 60 may also be coupled together by connection 61, 62 with normally open switches. The low voltage part of the design, 440V, 220V and 110V, is also customer specific and the arrangement of low voltage switchboards illustrated is just one option and not limited to only this arrangement.

Optional bow tunnel thrusters 63, 64 may be supplied from respective sides of the main switchboard 20, 21. A transformer 65, 67 and AC/AC converter 66, 68 bring the supply to the correct voltage for the thruster motors 69, 70. The example shown is based on a typical arrangement of a vessel with accommodation and the main switchboard mounted at the aft end of the vessel.

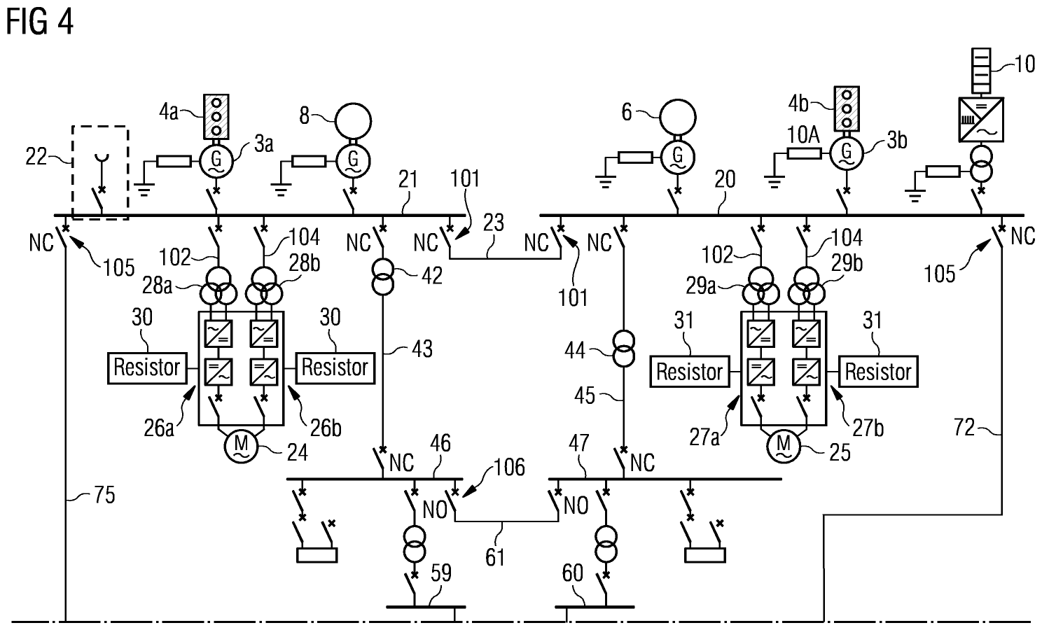

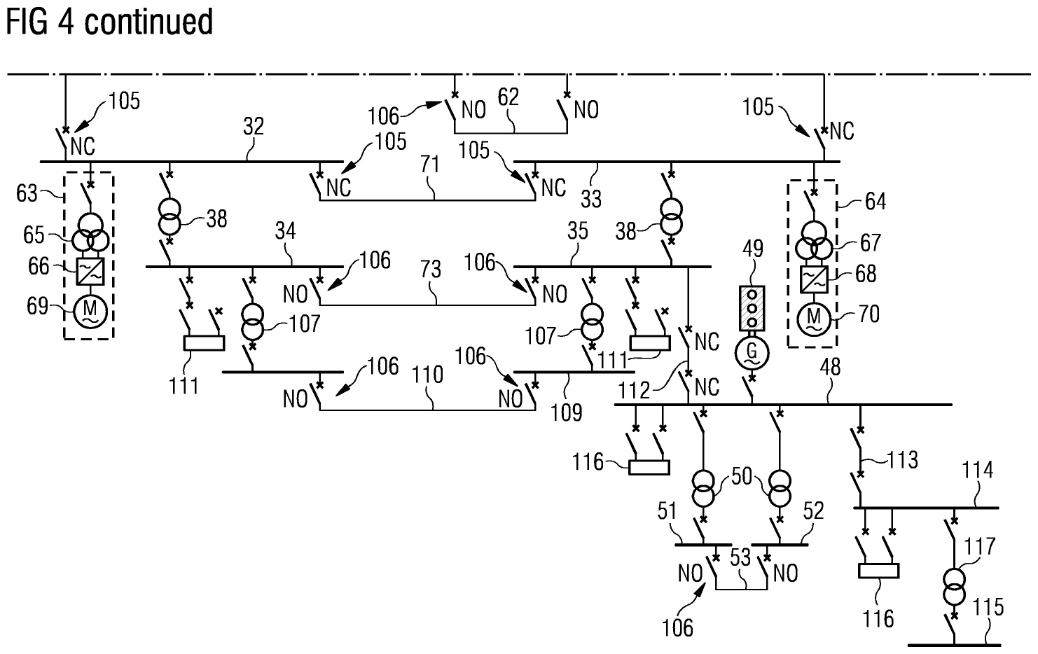

FIG. 4 is a single line diagram showing an alternative example of the arrangement, again with the power generation split between two AC buses, rather than the single AC bus of FIG. 1. By contrast with FIG. 3, the bow thrusters are connected to the forward AC buses and hotel loads are also taken off those buses, as this arrangement is suitable for a vessel where the accommodation and bridge are located at the forward end of vessel. As before, having the AC buses connected in a closed ring arrangement improve overall efficiency.

The energy storage 10 may include battery packs, in this example, battery packs producing 6 MW of power. As well as the energy storage 10, one of the auxiliary generators 3b, 4b, for example a spark ignited gas engine which may produce about 5.3MW of power; and a steam turbine 6, which may produce 5.7 MW of power, may all be connected to one AC bus, or switchboard 20, in this case, the port aft switchboard. These sources of power may produce fairly similar amounts of power. The gas turbine 8, the other auxiliary generator 3a, 4a and an optional shore supply connection 22 may be provided on a second AC bus 21. The two AC buses 20, 21, typically port and starboard aft on a twin engine vessel, may be coupled together via a coupling 23, with switches 101 normally closed. These switchboards are typically operated at 6.6 kV AC. Main propulsion is provided by electrical variable speed motors 24, 25, each producing about 10.5 MW of power, one coupled to each switchboard 20, 21. The generated power from the AC buses 20, 21 is fed through transformers 28a, 28b, 29a, 29b independently along cables 102, 104 to AC/DC, DC/AC converter circuits 26a, 26b, 27a, 27b to the motor. By contrast with the example of FIG. 1, the AC/AC conversion stages are not connected together via the DC connection 103, but remain independent, so each AC/AC converter 26a, 26b, 27a, 27b may need a breaking resistor 30, 31, rather than having common resistors for the AC/AC conversion. These resistors dissipate electrical energy created when the propeller is rotated by the water when reducing the speed of the ship. An alternative to the breaking resistor 30, 31 is for the energy generated to be stored in the energy storage system 10.

The aft main switchboards also have connections 43, 45 via transformers 42, 44 to aft utility switchboards 46, 47 operating at 440V AC, with switches 106 normally open. In this example, each of the port and starboard aft switchboards 47, 46 are shown connected, with switches normally closed, to a general service 230V UPS fed from an emergency switchboard 48, also at 440V AC, supplied by an emergency generator 49, located forward. The after switchboards 46, 47 also supply lower voltage switchboards 59, 60 via transformers, in this example at a lower voltage of 230V. The switchboards 59, 60 are also able to be coupled together, via switches 106, normally open.

Electrical power is also supplied from the main switchboard 20, 21 to subsidiary switchboards, such as a directly connected port and starboard forward switchboards 32, 33 also operating at 6.6 kV AC. The supply is to a closed ring formed by connections 75, 72, 71 with all switches 105 normally closed. The two forward switchboards 32, 33 are coupled together by the connection 71 with the switches 105 normally closed. Each of the forward switchboards 32, 33 may support an optional bow tunnel thruster 63, 64 including a three-phase transformer 65, 67, an AC/AC converter 66, 68 and thruster motor 69, 70. The forward switchboards 32, 33 may connect to lower voltage consumer switchboards 34, 35 via a transformer 38, 40 on each switchboard. A connection 73 between the lower voltage switchboards 34, 35 has switches 106 normally open in operation. In this example, the consumer switchboards operate at 440V AC. Each of these switchboards 34, 35 may supply a general service UPS, located forward and operating, in this example at 230V. A further set of connections via other transformers 107 to other consumer switchboards 108, 109 operating, in this example, at 230V AC may be provided. A connection 110 between these consumer switchboards 34, 35 has switches 106 normally open.

Unlike the example of FIG. 3, the emergency switchboard 48 is not connected to one of the aft main switchboards 20, 21, but to the forward lower voltage switchboard 35, in this example by a direct connection 112 to the 440V switchboard 35, with switches normally closed. The forward emergency switchboard 48, also at 440V AC, is supplied by the emergency generator 49 and from this, further 230V emergency switchboards 51, 52 may be supplied via transformers 50. These emergency switchboards 51, 52 may be coupled together through a coupling 53, set with switches 106 normally open. The forward emergency switchboard 48 also supplies an aft emergency switchboard 114, via connection 113, at 440V. Both forward and aft emergency switchboards 48, 114 supply a general service UPS 116. The aft emergency switchboard 114 also supplies another aft emergency switchboard 115 at a lower voltage, in this example, at 230V AC, via transformer 117. The UPS may be connected through an AC/DC rectifier (not shown). The low voltage part of the design is customer specific and other arrangements may be used.

FIG. 4 shows how the hybrid system operates when the power needed is only for idling and waiting. One auxiliary generator 4a or 4b, typically a spark ignited gas engine, is used for supplying electrical power to the complete ship, one auxiliary generator 4a or 4b is in hot standby mode and will auto start at failure and high load demand. Alternatively, a diesel engine or a dual fuel engine may be used. The spark ignited gas engines have the advantages of reducing emissions and simplifying, or reducing the cost of, the ship fuel system because only a single fuel, gas, is required. The energy storage 10 is on and used for peak shaving and blackout prevention. The normally closed ring connection distribution through 23, 71, 72 and 75 between the four AC bus sections 20, 21, 32 and 33 allows power to be transferred from one section to another as needed, so for the expected level of demand in idling and waiting, only one auxiliary generator needs to be operational. In these situations, the steam turbine 6 and gas turbine 8 are not normally running, so there is no need for combustion air cooling, or air lubrication to be on. Efficiency of the auxiliary generator is continuously measured and if it is determined to be below its rated value, steps are taken to determine the cause and address this, e.g. by cleaning filters. Predetermined thresholds are set for the length of time the load exceeds the provision from a single auxiliary generator and if passed, then the standby auxiliary generator is brought into operation or if load, or efficiency and power are below the norm for a single auxiliary generator when two are operational, then one is stopped and goes back into standby mode. The propulsion motors 24, 25 are not normally in operation when waiting, e.g., when anchored.

FIG. 4 illustrates how power for maneuvering and low speed operation is supplied. In this case, both auxiliary generators 4a, 3a, 4b, 3b supply electrical power to the complete ship, with the gas turbine 8 in hot standby, set to auto start at high load demand and/or if one of the auxiliary generators trips. The steam turbine 6 is also in standby mode. The energy storage 10 is on and used for peak shaving and blackout prevention. Both propulsion motors 24 and 25 are normally operating at low load. Air lubrication and combustion air cooling is off. Any drop in monitored efficiency, below a given threshold, will trigger investigation of the cause and appropriate maintenance action.

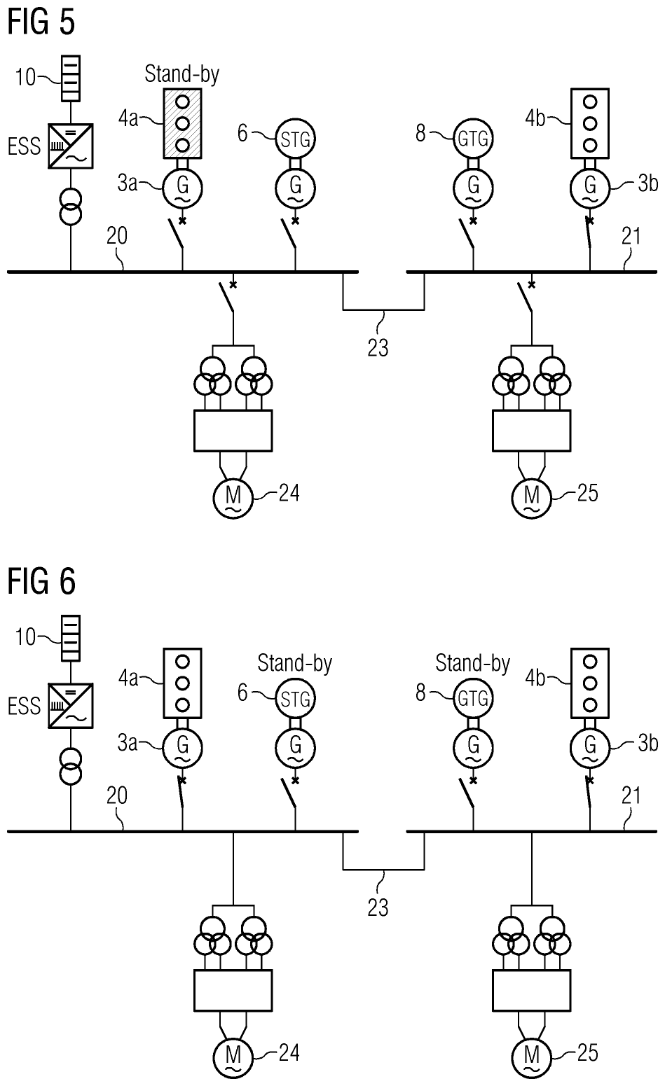

FIG. 5 shows the parts of the power system that are operational for unloading cargo. As with the situation in FIG. 4, both auxiliary generators 4a, 3a, 4b, 3b supply electrical power to the complete ship, with the gas turbine 8 normally in hot standby, set to auto start at high load demand and/or if one of the auxiliary generators trips. The steam turbine 6 is normally also in standby mode. The energy storage is on and used for peak shaving and blackout prevention. The propulsion motors 24, 25 are normally shut down and disconnected. Air lubrication and combustion air cooling are off. The auxiliary generator efficiency is continuously monitored to enable suitable maintenance action to be taken, if needed. If the load or efficiency measure is low and the power is less than that supplied by a single auxiliary generator for more than a predetermined time, then one of the two auxiliary generators is stopped and put back into standby mode.

FIG. 6 illustrates how the power system is operated for cargo loading. One auxiliary generator 4a, 3a or 4b, 3b is used for supplying electrical power to the complete ship, the other auxiliary generator 4a, 3a or 4b, 4b is in hot standby mode and will auto start at failure and high load demand. The energy storage 10 is on and used for peak shaving and blackout prevention. Combustion air cooling and air lubrication is off. Efficiency of the auxiliary generator is continuously measured and if it is determined to be below its rated value, steps are taken to determine the cause and address this, e.g. by cleaning filters. If load increases above that which a single auxiliary generator can supply, the standby generator is started. If the load or efficiency measure is low and the power is less than that supplied by a single auxiliary generator for more than a predetermined time, then one of the two auxiliary generators is stopped and put back into standby mode. The gas turbine and steam turbine are normally not operational. The propulsion motors are normally shut down and disconnected.

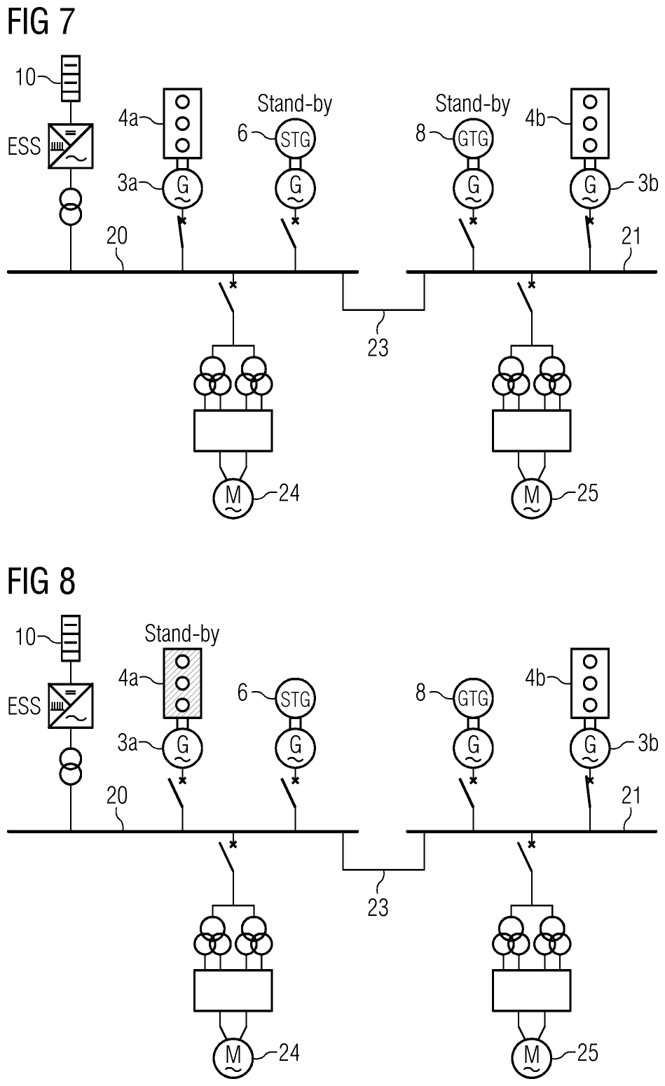

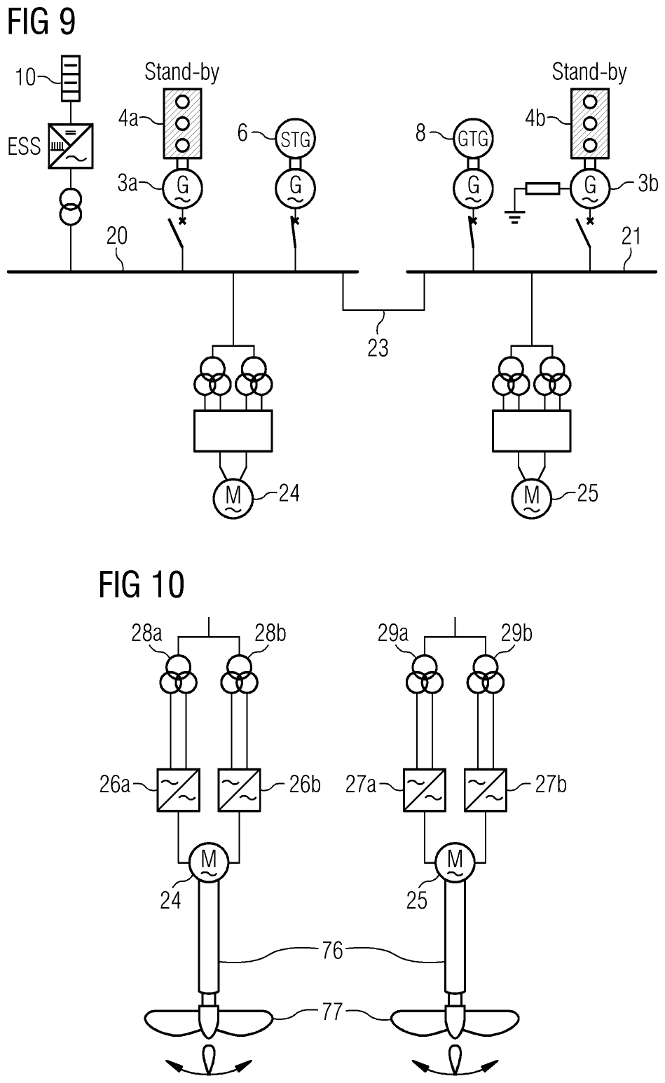

FIG. 7 illustrates power systems operation for a sea going voyage, in which a gas turbine generator 8 and steam turbine generator 6 are on and optimised for power and efficiency in supplying electrical power to the complete ship. In this example, both auxiliary generators 4a, 3a, 4b, 3b are in hot stand-by and auto start at high load demand or if the gas turbine generator 8 were to trip for any reason. The energy storage system 10 is on and in operation for peak shaving and blackout prevention. The air lubrication and combustion air cooling are on, as is the auxiliary boiler feedwater heating and weather routing. The propulsion system and motors 24, 25 are operational to propel the vessel, receiving electricity from the AC bus, which has been generated mainly by the gas turbine and steam turbine.

A minimum speed is set to meet a desired arrival time at the next port. Propulsion power is increased to the point where the gas turbine generator and steam turbine generator are operating above 90% rated power and as in all other modes efficiency is continuously measured, in this case of the combined gas turbine generator and the steam turbine generator. Suitable remedial action is taken if the efficiency drops below a rated value. The control system controls the air lubrication and propulsion power, whilst minimising the power to the re-liquification plant by careful use of the natural boil off gas. The most fuel efficient speed of operation is preferred and measurements of fuel consumption and distance travelled are made to keep this under review and make suitable adaptations.

FIG. 8 illustrates an example of using slow speed propulsion motors, without a gear box, for high efficiency drive lines, as prime movers. The ship is provided with two bi-directional motors 24, 25, which are driven by variable speed drives. The motors may operate in the range of zero to 75 revolutions per minute. Typically, each motor has two winding sets, each winding being three phase and 4.16 kV. The power range depends upon the application, for example, they may be set up for 8MW to 16MW. In as system as described the motors are highly efficient. The motors 24, 25 each drive a propeller 77 on a shaft 76. Electrical power obtained from the AC bus, passes through the AC/AC converters 26a, 26b, 27a, 27b and the transformers 28a, 28b, 29a, 29b. This arrangement allows unidirectional power flow, through diode rectifiers. The bi-directional permanent magnet slow speed propulsion motors do not require a gear box which further increase the propulsion efficiency as well as reducing the engine room space required for the propulsion motors.

The present invention has a number of benefits. In particular, it allows the operational cost of the vessel to be reduced, as the vessel can be operated with minimal maintenance crew onboard and with unmanned machinery space. Fuel spending is reduced, as compared with a dual fuel diesel electric (DFDE) as well as slow speed two-stroke direct drive with auxiliary engines, by using energy storage and fuel optimization. The carbon emissions and methane slip are reduced compared to a conventionally powered LNG carrier by using gas turbines in a hybrid combined cycle system. Lubrication oil consumption is also reduced compared to conventional LNG carriers and other ships. Operation in accordance with the present invention, reduces noise and vibration for the crew and the marine echo system. As the machinery is physically smaller and lighter, the vessel can take more cargo, giving a reduced unit freight cost. Replacing LNG with Hydrogen as fuel may be achieved, making the design attractive over the longer term too, as operators may have to move away from using fossil fuels to meet government requirements.

Use of electrical propulsion improves the maneuvering capabilities of the vessel, as well as the operational flexibility, whilst minimising noise and vibration for the crew and the marine ecosystem. In combination with condition-based monitoring, there is less need for maintenance and operational support may be provided remotely, onshore. The present invention enables the vessel to operate with greater efficiency at higher speed, reducing the number of days at sea for the same distance covered. The unit freight cost may be significantly reduced with the increased speed and additional cargo that can be carried in the available time. Using the hybrid combined cycle system of the present invention, the fuel consumption for the steam boiler may be reduced significantly. Minimal heat is required for the machinery compared to a 2-stroke solution. A propulsion management system (PMS) is provided with a fuel optimization function (ECO mode). Only a single fuel is used for all of the energy generation systems, which simplifies logistics and reduces the overall capital expenditure. There are fewer fuel tanks and fuel systems that need to be heated and overall, there is more space available for cargo. 4-stroke auxiliary generators, for example, spark plug ignited gas engines are inherently more efficient that 2 stroke engines.

1. A vessel hybrid combined cycle power and propulsion system, the system comprising a steam turbine, at least one gas turbine, at least one auxiliary generator; an electric propulsion drive system and an energy storage system, each connected to a section of an AC bus; the system further comprising a source of steam for the steam turbine, and a control system for controlling operation of the steam turbine, gas turbine, auxiliary generators, electric drive propulsion system and energy storage system; wherein the primary source of steam for the steam turbine is exhaust gas from the gas turbine; the primary source of gas for the gas turbine is boil off gas from the cargo hold; wherein the AC bus comprises a plurality of sections of AC bus coupled together by bus ties closed in normal operation forming a closed ring AC bus; and the electric propulsion drive system comprises a variable speed drive, driving an electric motor coupled through a drive shaft to a propeller.

2. A system according to claim 1, wherein the electric propulsion drive system comprises a permanent magnet motor.

3. A system according to claim 1, wherein the primary source of energy for the energy storage system is electricity generated by one of the steam turbine, gas turbine, or auxiliary generators.

4. A system according to claim 1, wherein the system further comprises a shore connection to enable the vessel consumers to be powered from the shore supply.

5. A system according to claim 1, wherein the system comprises a single fuel gas turbine and one or more spark ignited auxiliary generators.

6. A system according to claim 1, wherein the propulsion system electric motor comprises a low speed bi-directional motor coupled to each drive shaft and propellor of the vessel.

7. A system according to claim 1, wherein the propulsion system further comprises bow thrusters electrically coupled to the AC bus.

8. A system according to claim 5, wherein the vessel comprises a liquified natural gas carrier, LPG carrier, H2 carrier and other large ships

9. A system according to claim 1, wherein the electric motor comprises a bi-directional motor.

10. A system according to claim 1, wherein the system further comprises an onboard gas supply for the gas turbine.
